(19) United States
(12) Patent Application Publication
(10) Pub. No.: US 2026/0231195 A1
(43) Pub. Date: Aug. 6, 2026

(54) Slot Structures and Starting Symbols for Unlicensed Spectrum Sidelink Operations

(71) Applicant: Apple Inc., Cupertino, CA (US)

(72) Inventors: Chunxuan YE, San Diego, CA (US); Ankit BHAMRI, Haar (DE); Chunhai YAO, Beijing (CN); Dawei ZHANG, Saratoga, CA (US); Haitong SUN, Saratoga, CA (US); Hong HE, San Jose, CA (US); Huaning NIU, San Jose, CA (US); Seyed Ali Akbar FAKOORIAN, San Diego, CA (US); Wei ZENG, Saratoga, CA (US); Weidong YANG, San Diego, CA (US)

(21) Appl. No.: 19/154,179

(22) PCT Filed: Feb. 8, 2023
(86) PCT No.: PCT/CN2023/075014

§ 371 Date: Aug. 6, 2025

(51) Int. Cl. H04W 72/40; H04W 16/14; H04W 72/0446

(52) U.S. Cl. CPC H04W 72/40; H04W 72/0446; H04W 16/14

(57) ABSTRACT

A user equipment (UE) is configured to receive configuration information for a sidelink connection in an unlicensed frequency band, the configuration information comprising a first candidate starting symbol location for a slot, wherein the slot comprises a Physical Sidelink Control Channel (PSCCH) or a Physical Sidelink Shared Channel (PSSCH) transmission and determine a second candidate starting symbol location for the slot based on at least the first candidate starting symbol location.

### TECHNICAL FIELD

The present disclosure generally relates to wireless communication, and in particular, to slot structures and starting symbols for unlicensed spectrum sidelink operations.

### BACKGROUND

Several areas of User Equipment (UE) sidelink behavior in the unlicensed spectrum remain undefined. Specifically, a slot structure capable of supporting two starting symbols in a slot remains an open question. Additionally, UEs require a defined procedure of transmitting sidelink-synchronization signal blocks (S-SSBs).

### SUMMARY

Some exemplary embodiments are related to a method performed by a user equipment (UE). The method includes receiving configuration information for a sidelink connection in an unlicensed frequency band, the configuration information comprising a first candidate starting symbol location for a slot, wherein the slot comprises a Physical Sidelink Control Channel (PSCCH) or a Physical Sidelink Shared Channel (PSSCH) transmission and determining a second candidate starting symbol location for the slot based on at least the first candidate starting symbol location.

Other exemplary embodiments are related to a method performed by a user equipment (UE). The method includes receiving a first Physical Sidelink Control Channel (PSCCH) symbol in a slot of a sidelink transmission in an unlicensed frequency band, blind decoding the PSCCH symbol, wherein the blind decoding is successful, determining a condition and skipping a blind decoding operation for a second PSCCH symbol in the slot.

Still further exemplary embodiments are related to a method performed by a first user equipment (UE). The method includes receiving configuration information for a sidelink connection in an unlicensed frequency band comprising one or more primary sidelink-synchronization signal block (S-SSB) occasions and one or more secondary S-SSB occasions, wherein each primary S-SSB occasion corresponds to a predetermined number of secondary S-SSB occasions and determining whether the UE is allowed to transmit an S-SSB to a second UE at a primary S-SSB occasion.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary base station according to various exemplary embodiments.

FIG. 4 shows a flow diagram for determining the location of a second candidate starting symbol for sidelink operations, according to various exemplary embodiments.

FIG. 5A shows a diagram indicating AGC symbols for a sidelink resource pool containing more than one resource block (RB) set according to various exemplary embodiments.

FIG. 5B shows a diagram for a sidelink resource pool with simultaneous transmissions on different bandwidths according to various exemplary embodiments.

FIG. 6 shows an unlicensed S-SSB timing diagram according to various exemplary embodiments.

FIG. 7 shows a flow diagram for transmission of S-SSBs in the unlicensed spectrum according to various exemplary embodiments.

FIG. 8 shows a second unlicensed S-SSB timing diagram according to various exemplary embodiments.

FIG. 9 shows a second flow diagram for transmission of S-SSBs in unlicensed spectrum.

### DETAILED DESCRIPTION

The exemplary embodiments may be further understood with reference to the following description and the related appended drawings, wherein like elements are provided with the same reference numerals. The exemplary embodiments relate to improvements to UE sidelink operations in the unlicensed spectrum.

The exemplary embodiments are described with regard to a UE. However, reference to a UE is merely provided for illustrative purposes. The exemplary embodiments may be utilized with any electronic component that may establish a connection to an accessory device and is configured with the hardware, software, and/or firmware to exchange information and data with accessory devices. Therefore, the UE as described herein is used to represent any electronic component.

The exemplary embodiments are also described with reference to a 5G New Radio (NR) network. However, it should be understood that the exemplary embodiments may also be implemented in other types of networks, including but not limited to LTE networks, future evolutions of the cellular protocol (e.g., 6G networks), or any other type of network.

The exemplary embodiments are also described with reference to a sidelink connection. A sidelink connection may be generally understood as transmissions between UEs (e.g., phones, tablets, smartwatches, connected vehicles, etc.) without the need for a base station to transmit or receive data. Sidelink operations may be desirable in scenarios where ultra-low latency transmissions between connected devices are needed (e. g., connected vehicles).

Numerous areas of NR sidelink operations in the unlicensed spectrum are in need of further definition. As used herein, an unlicensed spectrum may include, but is not limited to, a spectrum (e.g., frequency band) in which spectrum access is contention based. Two such areas are defining a slot structure to support two starting symbols in a slot and defining a procedure for a UE to transmit a S-SSB. The exemplary embodiments pertain to these two areas of undefined UE unlicensed sidelink operations.

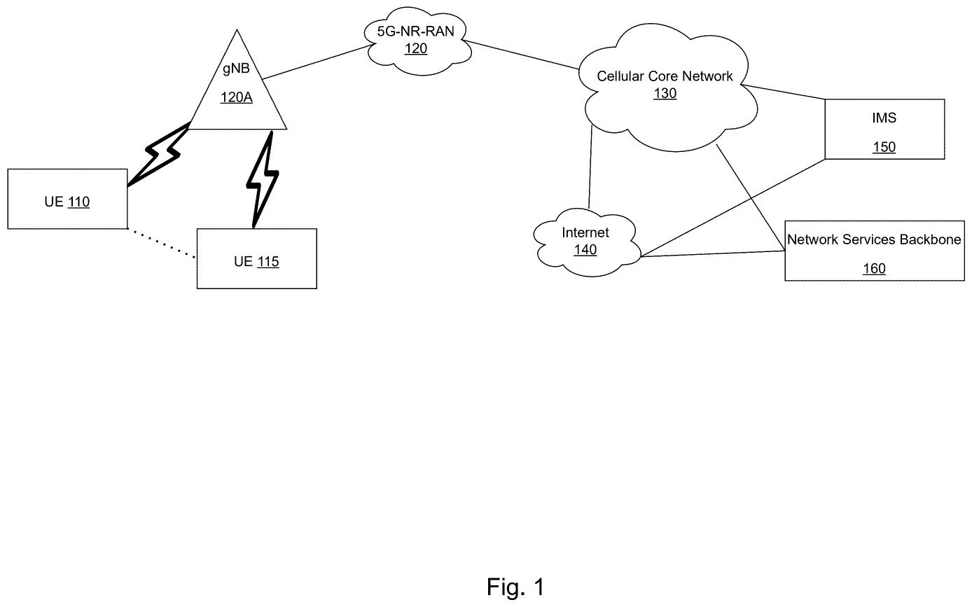

FIG. 1 shows an exemplary network arrangement 100 according to various exemplary embodiments. The exemplary network arrangement 100 includes a UE 110 and a UE 115. Those skilled in the art will understand that the UES 110 and 115 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of two UEs 110 and 115 is merely provided for illustrative purposes. Further description will relate to UE 110, but it should be understood that all description of UE 110 is applicable to UE 115 throughout this disclosure.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e.g., 5G cloud RAN, a next generation RAN (NG-RAN), a legacy cellular network, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120. The UE 110 may also communicate with the UE 115 over an unlicensed sidelink connection, wherein data is exchanged between the UE 110 and the UE 115 without the gNB 120A.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

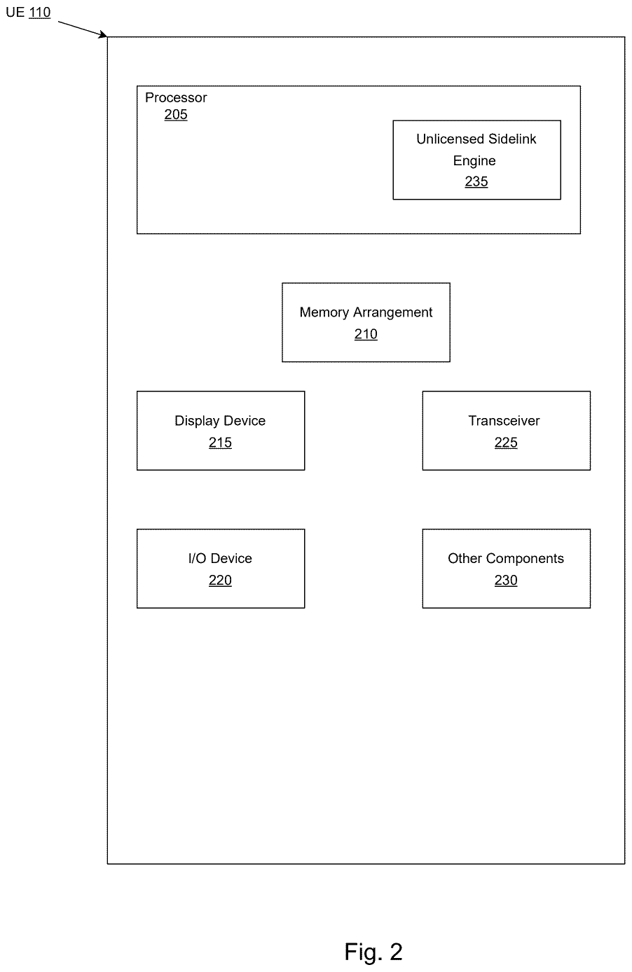

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include an Unlicensed Sidelink Engine 235 for performing operations such as generating slot structures capable of supporting two starting symbols in a slot and transmitting an S-SSB in unlicensed spectrum.

The above referenced engine being an application (e. g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs.

The display device 215 and the I/O device 220 may be separate components or integrated together such as a touchscreen. The transceiver 225 may be a hardware component configured to establish a connection with the 5G-NR RAN 120. Accordingly, the transceiver 225 may operate on a variety of different frequencies or channels (e.g., set of consecutive frequencies).

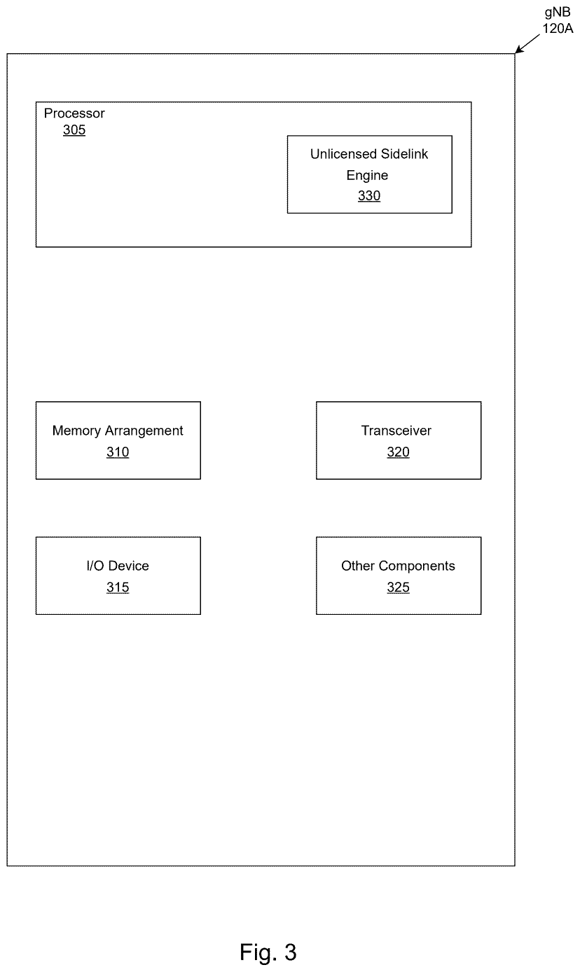

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the UE 110. For example, the engines may include an unlicensed sidelink engine 330 for performing operations such as generating (pre) configurations of S-SSBs, AGC symbols, and other sidelink parameters.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

In a first aspect of the exemplary embodiments, slot structures for supporting two starting symbols within a slot are disclosed. Variants of this aspect relate to the location of the second candidate starting symbol, symbol structure for automatic gain control purposes, and UE transmission monitoring of the physical sidelink control channel.

In a first variant of the first aspect, the location of the second candidate starting symbol depends upon the location of the first candidate starting symbol. A general description of this behavior may be illustrated by an example. It may be considered that the exemplary slot includes 14 symbols that are indexed from 0 . . . 13. If the location of a first candidate starting symbol is at X, where 0≤X≤13, the location of a second starting symbol, Y, may be determined.

In a first alternative of the first variant, the location of the starting symbol, Y, may be determined by the following equation: Y=X+ceil ((13−X)/2) ), where ceil is the ceiling function of a real number. As an example, using the equation of the first alternative, if X=2, then Y=8.

In a second alternative of the first variant, the location of the starting symbol, Y, may be determined by the following equation: Y=X+floor ((13−X)/2) ), where floor is the floor function of a real number. As an example, using the equation of the second alternative, if X=2, then Y=7.

One of skill in the art will recognize that the above equations are only exemplary, and that other possible equations and bounds for the independent variable X (i.e., the first candidate starting symbol location) are possible.

The results from the above alternative equations for determining the second candidate starting symbol location may include an upper bound (e.g., the latest possible location of the second candidate starting symbol). For example, in the examples provided above, the upper bound may be defined as Y≤8 for the latest possible location of the second candidate starting symbol. If the Y value calculated from either alternative equation above is above the upper bound, two options exist. In a first option, Y may be taken as the upper bound (e.g., if Y exceeds the upper bound, Y may instead be defined as the upper bound). In a second option, it may be determined/declared that the slot does not support the starting candidate symbol.

The value of X may be (pre-) configured, e.g., equal to the parameter sl-StartSymbol in a sidelink bandwidth part (BWP) (pre) configuration.

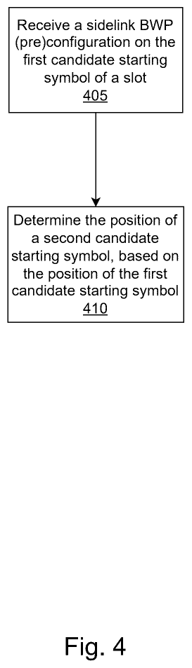

FIG. 4 shows a flow diagram for determining the location of a second candidate starting symbol for sidelink operations, according to various exemplary embodiments. FIG. 4 corresponds with the first aspect of the exemplary embodiments.

In 405, a UE (e.g., UE 110) receives a sidelink bandwidth part (pre) configuration on a first candidate starting symbol of a slot. The UE may receive this BWP configuration from the gNB 120A or from a locally restored pre-configuration.

In 410, the UE 110 determines the position of a second candidate starting symbol, based on the position of the first candidate starting symbol. Operation 410 may utilize the equations mentioned above to determine the location of the second candidate starting symbol, though other relationships or equations defining the location of the second symbol based on the first symbol are also possible.

In a second variant of the first aspect of the exemplary embodiments, symbols that may be used for automatic gain control (AGC) purposes are defined. AGC is utilized for dynamic adjustment of gain to reduce the interference of unwanted received signals. The embodiments of the second variant may be understood to apply to different scenarios where the Physical Sidelink Control Channel (PSCCH) /Physical Sidelink Shared Channel (PSSCH) transmission has one or two symbols for AGC purposes, depending on various conditions. In the exemplary embodiments, it is assumed that the PSCCH/PSSCH transmission starts from a first starting symbol. However, this is not a requirement of the exemplary embodiments.

In a first option of the second variant, the determination of the symbols that are used for AGC is defined in a semi-static manner based on the number of resource block (RB) sets in a resource pool. If a resource pool contains only a single RB set, then the PSCCH and/or PSSCH transmission may have one symbol for AGC purposes, e.g., the first starting symbol.

One of skill in the art will recognize that UEs operating in the unlicensed spectrum in the same resource pool perform listen-before-talk (LBT) before transmitting. That is, if a first UE is currently transmitting in a given resource pool, an unrelated UE will not transmit because of the shared resource pool and the LBT operation. Without a simultaneous transmission on the resource pool, there is no need to transmit a second AGC symbol.

On the other hand, if a resource pool includes more than one RB set, the PSCCH/PSSCH transmissions may have two symbols for AGC purposes.

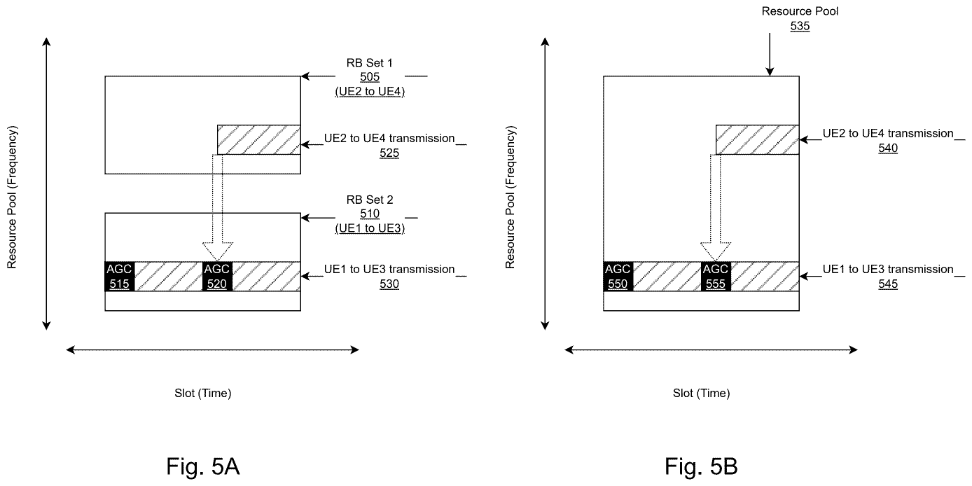

FIG. 5A shows a diagram indicating AGC symbols for a sidelink resource pool containing more than one resource block (RB) set according to various exemplary embodiments. It should be understood that FIG. 5A illustrates an example of a resource pool including more than one RB set, resulting in there being two symbols for AGC purposes according to the first option of the second variant.

FIG. 5A shows UE 1, UE 2, UE 3, and UE 4. The UEs 1 and 3 have an ongoing sidelink connection 530 (specifically with the UE1 transmitting to the UE3). The UEs 2 and 4 have an ongoing sidelink connection 525 (specifically with the UE2 transmitting to the UE4). Any of the UEs 1-4 should be understood to be analogous to the UE 110 described above with respect to FIG. 2.

In this example, the resource pool includes the RB Set 1 505 and RB Set 2 510. In the RB Set 2 510, the UE1 is transmitting to the UE3 as part of an ongoing sidelink transmission 530. Also, in the RB set 1 505, the UE2 is transmitting to the UE4 as part of an ongoing sidelink transmission 525. As shown in FIG. 5A, some symbols of the transmission 525 in the RB set 1 505 overlap with the symbols of the transmission 530 in the RB Set 2 510. It is possible that the transmission 525 between the UE2 and the UE4 may result in bleed over into the transmission 530 between the UE1 and the UE3 (e.g., the close proximity in frequency between the symbols may cause the UE3 to receive a portion of the information that is being transmitted in transmission 525).

Typically, the first symbol of a slot is an AGC symbol. This is depicted in FIG. 5A by AGC symbol 515 of the transmission 530. However, as described above, in the first option of the second variant, a second symbol may also be used for AGC purposes to compensate for the potential bleed over of the transmission 525 on the RB set 1 505 into the transmission 530 on the RB set 2 510. This additional AGC symbol 520 that aligns in time with the first symbol of the transmission 525 assists the UE3 to compensate for any bleed over of the transmission 525. The defining of a second AGC symbol may also be repeated in future slots (not shown).

In a second option of the second variant, the determination of the symbols that are used for AGC is also defined in a semi-static manner. In this option, the resource pool may be (pre) configured as to whether the PSCCH/PSSCH transmission has one or two symbols for AGC purposes.

For example, if a resource pool contains only a single RB set, then the resource pool may be (pre) configured such that the PSCCH/PSSCH transmissions include 1 symbol for AGC purposes. If a resource pool contains more than one RB set, then the resource pool may be (pre) configured such that the PSCCH/PSSCH transmissions include one or two symbols for AGC purposes.

In another example, if a resource pool contains only a single RB set, then the resource pool always has 1 symbol for AGC purposes. If a resource pool contains more than one RB set, then the resource pool may be (pre) configured such that the PSCCH/PSSCH transmissions include one or two symbols for AGC purposes.

In a third option of the second variant, the determination of the symbols that are used for AGC is defined in a dynamic manner based on a bandwidth of the PSCCH/PSSCH transmission. Specifically, if the PSCCH/PSSCH transmission occupies the full bandwidth of the resource pool, then the PSCCH/PSSCH transmission may have one symbol for AGC purposes.

This is because an unrelated UE will perform an LBT procedure and not transmit if it detects that a UE is currently transmitting over an entire bandwidth of the resource pool, e.g., the entire resource pool is occupied.

On the other hand, if the PSCCH/PSSCH transmission occupies only a partial bandwidth of the resource pool, the PSCCH/PSSCH transmission may have two symbols for AGC purposes. It should be noted that this is distinct from the operations described with respect to FIG. 5A, which applies to two separate resource pools.

FIG. 5B shows a diagram for a sidelink resource pool with simultaneous transmissions on different bandwidths according to various exemplary embodiments. In contrast to FIG. 5A, in FIG. 5B the resource pool 535 includes only a single RB set, e.g., the RB set spans the entire resource pool 535.

FIG. 5B shows UE 1, UE 2, UE 3, and UE 4. The UEs 1 and 3 have an ongoing sidelink connection 545 (specifically with the UE1 transmitting to the UE3). The UEs 2 and 4 have an ongoing sidelink connection 540 (specifically with the UE2 transmitting to the UE4). Again, any of the UEs 1-4 should be understood to be analogous to the UE 110 described above with respect to FIG. 2.

In this example, the UE1 is transmitting to the UE3 as part of an ongoing sidelink transmission 545 in the resource pool 535. However, it may be considered that the transmission 545 does not occupy the entire bandwidth of the resource pool 535. Thus, this also allows the UE2 to transmit to the UE4 as part of an ongoing sidelink transmission 540 in a bandwidth part of the resource pool 535 that is not occupied by the transmission 545. As shown in FIG. 5B, some symbols of the transmission 540 overlap with the symbols of the transmission 545. Thus, according to the third option of the second variant, the transmission 545 may have 2 symbols (AGC 550 and AGC 55) that are used for AGC purposes. The AGC symbol 550 is the first starting symbol and the AGC symbol 555 aligns in time with the first symbol of the transmission 540.

In a third variant of the first aspect of the exemplary embodiments, receiver UE monitoring operations for PSCCH are disclosed. If a sidelink receiving UE successfully decodes a PSCCH corresponding to the first candidate starting symbol in a slot (i.e., before a second candidate starting symbol), several conditions may cause the receiving UE to not perform further PSCCH blind decoding operations. Any of the following conditions, alone or in combination, may cause the receiving UE to not perform further PSCCH blind decoding operations.

The first condition is if the PSSCH transmission corresponding to a decoded PSCCH is a full bandwidth transmission across the whole resource pool. In this case, the receiving UE is assured that the decoded PSCCH corresponds to any transmissions that the receiving UE is to receive because when the PSSCH transmission occupies the entire bandwidth of the resource pool, there can be no other PSCCH transmissions within the resource pool.

The second condition is if the resource pool comprises only a single RB set. Similar to the above condition, when this condition occurs, the receiving UE is assured that no other transmissions are destined for the receiving UE in the resource pool.

The third condition is if the receiving UE has reached the maximum number of blind decoding attempts. In this condition, the receiving UE has reached its maximum limit for decoding attempts and will not attempt any further decoding of this PSCCH.

In a second aspect of the exemplary embodiments, operations relating to UE Sidelink-Synchronization Signal Block (S-SSB) procedure are disclosed. One of skill in the art will appreciate that in licensed bands, S-SSBs are transmitted on a periodic basis. For example, Rel-16 and Rel-17 define such a period as 160 ms. It is conceivable that in future releases, S-SSBs will be able to transmit in unlicensed bands periodically. It is possible that unlicensed S-SSBs may be transmitted with a period similar to or identical to that of licensed S-SSB transmissions (i.e., 160 ms). However, the exemplary embodiments are not limited to this period, but may be applied to any period that is defined for the unlicensed band.

It should be understood that any reference to Rel-16 and Rel-17 in the following portions of the disclosure refer to unlicensed S-SSB transmissions having a transmission period equivalent to S-SSB transmissions in the licensed portion of the spectrum. The use of the licensed periodicity and 160 ms are only exemplary. One of skill in the art will recognize that the unlicensed periodicity can be any desired value, and that the unlicensed periodicity need not have any relation to the periodicity of licensed S-SSB transmissions. It should be further understood that reference to a “primary” S-SSB or S-SSB occasion may refer to Rel-16 and Rel-17 transmission intervals, but need not exclusively refer to Rel-16 and Rel-17 transmission intervals. “Primary” S-SSBs or S-SSB occasions are used in this disclosure to refer to S-SSBs/S-SSB occasions that may come first (and fail) for additional (i.e., non-primary) S-SSBs to be transmitted at additional S-SSB occasions.

Transmission of additional candidate S-SSB occasions may be useful in the unlicensed spectrum, in which a UE is competing with other nearby UEs for time and frequency resources to transmit. The increased transmission density of unlicensed spectrum invariably leads to transmission collisions resulting in S-SSBs that are not received by the intended UE. It follows that transmitting additional candidate S-SSBs will alleviate the issues related to S-SSB transmission in unlicensed spectrum.

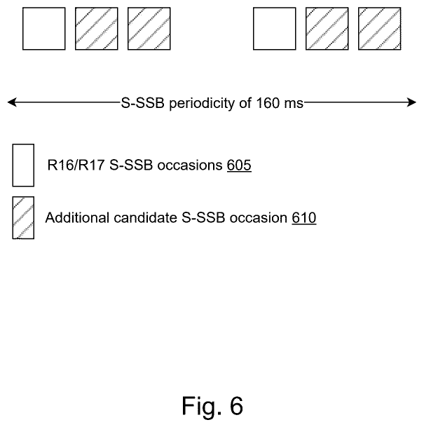

FIG. 6 shows an unlicensed S-SSB timing diagram according to various exemplary embodiments. Of note is that Rel-16 and Rel-17 S-SSB occasions 605 occur at a periodic cadence of 160 ms (in this instance with two S-SSB occasions). It should again be emphasized that the 160 ms period and two Rel-16 and Rel-17 S-SSB 605 occasions per period are only exemplary.

Of further note in FIG. 6 are additional candidate S-SSB occasions 610, represented by crosshatched boxes. The addition of additional candidate S-SSB occasions increases the likelihood of successful S-SSB transmission on the crowded unlicensed spectrum.

When additional candidate S-SSB occasions 610 are added, there may be two primary scenarios. In a first scenario, each Rel-16/Rel-17 sidelink S-SSB slot has K corresponding additional S-SSB occasions, and the gap between the S-SSB occasions is (pre) configured. Returning briefly to FIG. 6, in that example, each Rel-16/Rel-17 sidelink S-SSB slot 605 has K=2 additional S-SSB occasions (i.e., the two crosshatched boxes following each empty box). The gap between each of the S-SSB occasions (e.g., the gap between the first Rel-16/Rel-17 sidelink S-SSB slot 605 and the first additional S-SSB occasion 610 and the gap between the first additional S-SSB occasion 610 and the second additional S-SSB occasion) may be (pre) configured, e.g., 40 ms, 50 ms, 60 ms, etc.).

The second scenario may be when the number of candidate S-SSB occasions are (pre) configured, and the locations are determined based on the (pre) configured number. For example, the number of S-SSB occasions may be divided by the period and distributed within the period.

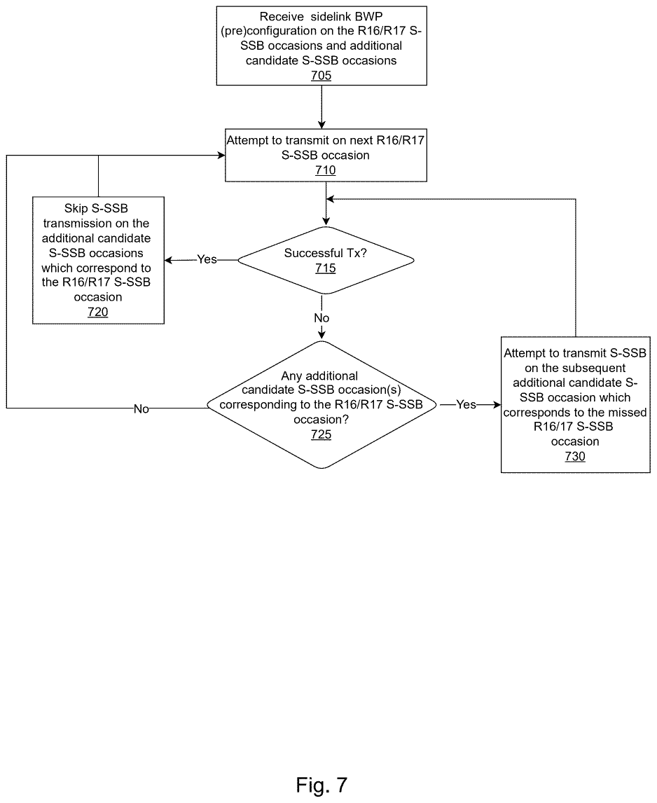

FIG. 7 shows a flow diagram for transmission of S-SSBs in the unlicensed spectrum according to various exemplary embodiments. Again, it should be understood that Rel-16/Rel-17 S-SSB occasions refers to a periodic transmission interval that is only exemplary and based on legacy periodic transmission intervals of S-SSBs in licensed spectrum (e.g., a periodic interval as depicted in FIG. 6). Other S-SSB occasion intervals are possible and the example of Rel-16/Rel-17 S-SSB occasions is only exemplary.

In 705, a UE (e.g., UE 110) receives a sidelink BWP (pre) configuration for the Rel-16/Rel-17 S-SSB occasions, and additional candidate S-SSB occasions. As described above, each Rel-16/Rel-17 S-SSB occasion may have K corresponding additional candidate S-SSB occasions.

In 710, the UE 110 attempts to transmit an S-SSB on the next Rel-16/Rel-17 occasion. This may be represented by the first block (from the left) in FIG. 6, though this is only exemplary. As described above, because the UE 110 is transmitting in the unlicensed spectrum, the UE 110 will perform an LBT procedure (or some other clear channel procedure) to determine if the UE 110 can occupy the channel to transmit the S-SSB in the desired occasion.

In 715, the UE 110 determines if the S-SSB transmission was successful in the Rel-16/Rel-17 S-SSB occasion. If it was successful, the UE 110 proceeds to 720. In 720, because the S-SSB transmission 710 was successful, the UE 110 skips transmitting the S-SSB on the additional candidate S-SSB occasions which correspond to the Rel-16/Rel-17 S-SSB occasion. Another manner of expressing the skipping is that any remaining additional candidate S-SSB occasions that occur before the next Rel-16/Rel-17 S-SSB occasion may be skipped. The UE 110 then proceeds to 710 for the next S-SSB transmission attempt on an R16/R17 occasion.

If the transmission 710 is not successful (the “no” path of 715), the UE 110 proceeds to 725. In 725, the UE 110 determines whether there exists any additional S-SSB occasion(s) corresponding to the Rel-16/Rel-17 S-SSB occasion. Again, another manner of expressing this operation is that it is determined if there are any remaining additional candidate S-SSB occasions that occur before the next Rel-16/Rel-17 S-SSB occasion. If there are not any additional S-SSB occasion(s) corresponding to the Rel-16/Rel-17 S-SSB occasion, the UE 110 proceeds back to 710 to attempt to transmit on the next Rel-16/Rel-17 S-SSB occasion.

If There are additional S-SSB occasion(s) corresponding to the Rel-16/Rel-17 S-SSB occasion, the UE 110 proceeds to 730. In 730, the UE 110 attempts to transmit S-SSBs on the subsequent additional candidate S-SSB occasion(s) which corresponds to the missed Rel-16/Rel-17 S-SSB occasion, e.g., the remaining additional candidate S-SSB occasions that occur before the next Rel-16/Rel-17 S-SSB occasion. The UE 110 then proceeds to 715 to confirm if the S-SSB transmission was successful.

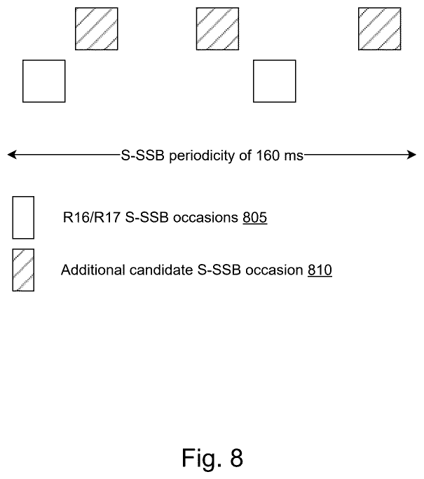

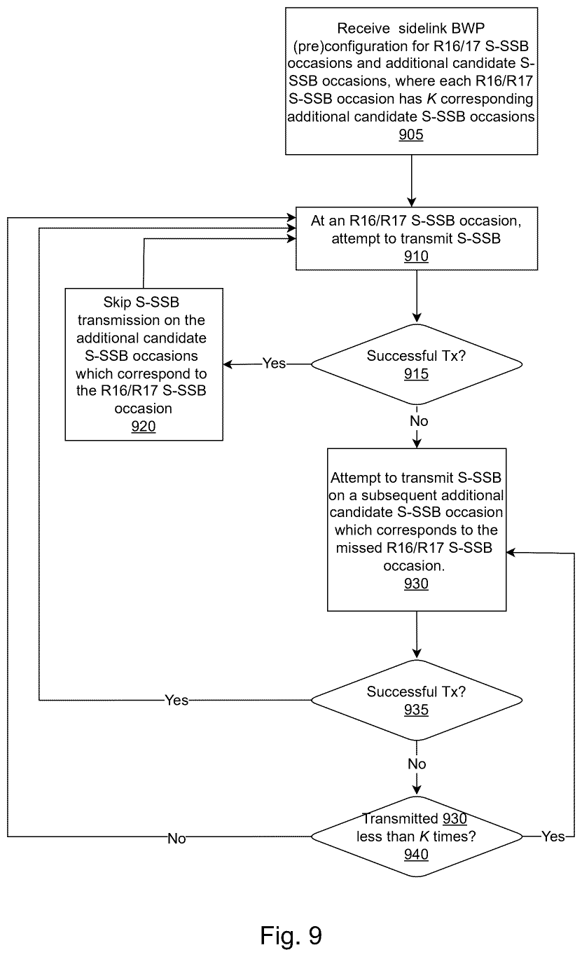

FIG. 8 and FIG. 9 Relate to a scenario in which the number and location(s) of additional candidate S-SSB occasions are separately (pre) configured. In the exemplary embodiments, if there is an overlap in time between an additional candidate S-SSB occasion and a Rel-16/Rel-17 occasion, the additional candidate S-SSB occasion should be ignored, because additional candidate S-SSBs are used to compensate for potential Rel-16/Rel-17 S-SSB transmission failure.

FIG. 8 shows a second unlicensed S-SSB timing diagram according to various exemplary embodiments. It should understood that the differing heights of the S-SSB occasions 805 and 810 does not indicate different transmission frequencies (e.g., there is no y-axis that indicates frequency in this diagram). Instead, the differing heights of the S-SSB occasions is used to emphasize that the R16/R17 S-SSB occasions 805 and the additional candidate S-SSB occasions 810 are configured separately. It is noted that the Rel-16/Rel-17 S-SSBs 805 and the additional S-SSBs 810 may be transmitted at different frequencies.

FIG. 9 shows a second flow diagram for transmission of S-SSBs in unlicensed spectrum according to various exemplary embodiments. In 905, a UE (e.g., UE 110) receives a sidelink BWP (pre) configuration both for Rel-16/Rel-17 S-SSB occasions 805 and for additional candidate S-SSB occasions 810. Each Rel-16/Rel-17 S-SSB occasion 805 has K corresponding additional candidate S-SSB occasions 810 (e. g., in the example of FIG,. 8, there are two (2) additional candidate S-SSB occasions 810 per Rel-16/Rel-17 S-SSB occasion 805). One of skill in the art will appreciate that reference to Rel-16/Rel-17 S-SSB occasion 805S-SSB occasions is only exemplary, and that other S-SSB periodicities are possible.

In 910, the UE 110 attempts to transmit an S-SSB at an R16/R17 S-SSB occasion. In 915, the UE determines whether the transmission 910 was successful. If the transmission was successful, the UE 110 proceeds to 920. In 920, the UE 110 skips S-SSB transmission on the additional candidate S-SSB occasions which correspond to the R16/R17 S-SSB occasion. Similar to the operation 720 described above, another manner of expressing the skipping is that any remaining additional candidate S-SSB occasions that occur before the next Rel-16/Rel-17 S-SSB occasion may be skipped. For example, the UE 110 may not transmit the crosshatched additional S-SSB occasion as depicted in FIG. 8.

If the UE 110 determines in 915 that the transmission 910 was unsuccessful, the UE 110 proceeds to 930. In 930, the UE 110 attempts to transmit an S-SSB on a subsequent additional candidate S-SSB occasion 810 which corresponds to the missed Rel-16/Rel-17 S-SSB occasion 805, e.g., the remaining additional candidate S-SSB occasions that occur before the next Rel-16/Rel-17 S-SSB occasion. If the transmission 930 is successful, the UE 110 proceeds back to 910 to attempt to transmit the next S-SSB at an Rel-16/Rel-17 occasion 805. If transmission 930 is unsuccessful, the UE 110 proceeds to 940. In 940, if the UE 110 has transmitted 930 less than K times, it proceeds back to 930. This may be understood as the UE transmitting the second (from the left) crosshatched S-SSB in FIG. 8 should the first (from the left) crosshatched S-SSB in FIG. 8 fail. If UE 110 has not transmitted 930 less than K times (i.e., it has transmitted K times), the UE 110 proceeds back to 910 to attempt to transmit an S-SSB at the next R16/R17 occasion.

### EXAMPLES

In a first example, a method is performed by a first user equipment (UE), comprising receiving configuration information for a sidelink connection in an unlicensed frequency band comprising one or more primary sidelink-synchronization signal block (S-SSB) occasions and one or more secondary S-SSB occasions, wherein each primary S-SSB occasion corresponds to a predetermined number of secondary S-SSB occasions and determining whether the UE is allowed to transmit an S-SSB to a second UE at a primary S-SSB occasion.

In a second example, the method of the first example, wherein determining whether the UE is allowed to transmit the S-SSB to the second UE at the primary S-SSB occasion is based on one of a listen before talk (LBT) operation or a clear channel assessment (CCA) operation.

In a third example, the method of the first example, wherein the configuration information further comprises a timing gap between each primary S-SSB occasion and a first one of the one or more secondary S-SSB occasion, and a timing gap between each of the one or more secondary S-SSB occasions.

In a fourth example, the method of the first example, wherein a timing location of the secondary S-SSB occasions correspond to a number of the one or more secondary S-SSB occasions.

In a fifth example, the method of the first example, wherein the one or more primary S-SSB occasions have a period of 160 ms.

In a sixth example, the method of the first example, wherein the one or more secondary S-SSB occasions are configured separately from the one or more primary S-SSB occasions.

In a seventh example, the method of the sixth example, further comprising when a separately configured secondary S-SSB occasion overlaps in time with a primary S-SSB occasion, ignoring the separately configured S-SSB occasion.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A method performed by a user equipment (UE), comprising:
receiving configuration information for a sidelink connection in an unlicensed frequency band, the configuration information comprising a first candidate starting symbol location for a slot, wherein the slot comprises a Physical Sidelink Control Channel (PSCCH) or a Physical Sidelink Shared Channel (PSSCH) transmission; and
determining a second candidate starting symbol location for the slot based on at least the first candidate starting symbol location.

2. The method of claim 1, wherein determining the second candidate starting symbol is based on an equation: Y=X+ceil ((13−X)/2) ), where Y is the second candidate starting symbol location, X is the first candidate starting symbol location and the ceil is the ceiling function of a real number.

3. The method of claim 1, wherein determining the second candidate starting symbol is based on an equation: Y=X+floor ((13−X)/2) ), where Y second candidate starting symbol, X is the first candidate starting symbol and the floor is the floor function of a real number.

4. The method of claim 1, wherein the configuration information comprises an upper bound value for the second candidate starting symbol location.

5. The method of claim 4, wherein, when a value of the second candidate starting symbol location exceeds the value of the upper bound, the second candidate starting symbol is defined as being equal to the value of the upper bound.

6. The method of claim 4, wherein, when a value of the second candidate starting symbol location exceeds the value of the upper bound, the slot is determined to not support the second candidate starting symbol.

7. The method of claim 1, wherein the first candidate starting symbol included in the configuration information comprises an sl-StartSymbol parameter.

8. The method of claim 1, further comprising:
determining a number of symbols in the slot that include information for automatic gain control (AGC) purposes.

9. The method of claim 8, wherein determining the number of symbols comprises:
determining whether a sidelink resource pool contains a single resource block (RB) set or more than one RB set,
wherein, when the sidelink resource pool contains a single RB set, the number of symbols in the slot that include information for automatic gain control (AGC) purposes is one, and
when the sidelink resource pool contains more than one RB set, the number of symbols in the slot that include information for automatic gain control (AGC) purposes is two.

10. The method of claim 8, wherein the number of symbols in the slot that include information for automatic gain control (AGC) is based on a configuration or preconfiguration of a sidelink resource pool for the slot.

11. The method of claim 8, wherein determining the number of symbols comprises:
determining whether the PSCCH or PSSCH transmission occupies a full bandwidth of a sidelink resource pool or a partial bandwidth of the sidelink resource pool,
wherein, when the PSCCH or PSSCH transmission occupies the full bandwidth of the sidelink resource pool, the number of symbols in the slot that include information for automatic gain control (AGC) purposes is one, and
when the PSCCH or PSSCH transmission occupies the partial bandwidth of the sidelink resource pool, the number of symbols in the slot that include information for automatic gain control (AGC) purposes is two.

12. A method performed by a user equipment (UE), comprising:
receiving a first Physical Sidelink Control Channel (PSCCH) symbol in a slot of a sidelink transmission in an unlicensed frequency band;
blind decoding the PSCCH symbol, wherein the blind decoding is successful;
determining a condition; and
skipping a blind decoding operation for a second PSCCH symbol in the slot.

13. The method of claim 12, wherein the condition comprises a Physical Sidelink Shared Channel (PSSCH) transmission corresponding to the PSCCH symbol occupies a full bandwidth of a sidelink resource pool.

14. The method of claim 12, wherein the condition comprises that a sidelink resource pool including the PSCCH symbol comprises only one resource block (RB) set.

15. The method of claim 12, wherein the condition comprises the UE having reached a maximum number of blind PSCCH decoding attempts.

16. A method performed by a first user equipment (UE), comprising:
receiving configuration information for a sidelink connection in an unlicensed frequency band comprising one or more primary sidelink-synchronization signal block (S-SSB) occasions and one or more secondary S-SSB occasions, wherein each primary S-SSB occasion corresponds to a predetermined number of secondary S-SSB occasions; and
determining whether the UE is allowed to transmit an S-SSB to a second UE at a primary S-SSB occasion.

17. The method of claim 16, further comprising:
when the UE is allowed to transmit the S-SSB at the primary S-SSB occasion, skipping transmitting the S-SSB at any of the corresponding one or more secondary S-SSB occasions.

18. The method of claim 16, further comprising:
when the UE is not allowed to transmit the S-SSB at the primary S-SSB occasion, determining whether the UE is allowed to transmit the S-SSB to the second UE at a first corresponding secondary S-SSB occasion.

19. The method of claim 18, further comprising:
when the UE is allowed to transmit the S-SSB at the first secondary S-SSB occasion, skipping transmitting the S-SSB at any remaining corresponding one or more secondary S-SSB occasions.

20. The method of claim 18, further comprising:
when the UE is not allowed to transmit the S-SSB at the first secondary S-SSB occasion, determining whether there are any remaining corresponding secondary S-SSB occasions; and
when there is at least one remaining corresponding secondary S-SSB occasion, determining whether the UE is allowed to transmit the S-SSB to the second UE at the at least one remaining corresponding secondary S-SSB occasion.
